(19) United States
(12) Patent Application Publication
(10) Pub. No.: US 2012/0288748 A1
(43) Pub. Date: Nov. 15, 2012

(54) METHOD OF MANUFACTURING BATTERY, AND BATTERY

(76) Inventors: Takahiro OSHIMA, Nagoya-shi (JP); Masanori MATSUBARA, Kasugai-shi (JP)

(21) Appl. No.: 13/477,111

(22) Filed: May 22, 2012

Related U.S. Application Data
(63) Continuation of application No. PCT/JP2010/000114, filed on Jan. 12, 2010.

(51) Int. Cl. H01M 2/06; H01M 2/30

(52) U.S. Cl. 429/179; 29/623.2

(57) ABSTRACT

The present invention provides a battery with high sealing property at the fitted portion among the case and the terminal. In the embodiment, the electric terminal has the groove formed on the outer periphery along the whole circumference of the terminal, and the groove has an outer edge line at the outer side of the case. The lid is provided with the through hole around which the flanged portion stands outward from the case. The terminal surrounded by the insulating member is inserted into the hole such that the groove faces a section of the lid having thickness in the axial direction of the terminal. Plastically deforming the upper area in the flanged portion above the edge line of the groove positioned at the outer side of the case and forming the press-fitted portion provides the fitted portion between the terminal and the hole.

### TECHNICAL FIELD

The present invention relates to a method of manufacturing a battery and a battery, especially to the battery including an electric terminal fitted into a case with penetrating therethrough and projecting therefrom, in which the sealing property at the fitted portion is improved.

### BACKGROUND ART

The case served as a housing of the battery includes a box and a lid. The box contains an electrode body as a power generating element and has an opening to form a closed-end shape. The plate lid has a shape in accordance with the opening of the box to cover it.

The lid has a pair of through holes from which electric terminals are projected outward. The terminals serve as the positive and negative electrode terminal for transmitting the electric power from the element.

The case is provided with a safety unit such as a relief valve penetrating therethrough in the thickness direction. For example, the relief valve works in the case that the defect such as a short circuit results in generation of large volume of gas, communicating the inside of the battery with the outside to prevent the internal pressure from increasing.

When the battery is a nonaqueous electrolyte secondary battery such as a lithium ion secondary battery, the contamination of water into the battery has an influence on the battery performance, so that the sealing property has to be secured. Furthermore, considering when the inner pressure raises caused by the inside defect, it is worth to seal the other portions to operate the safety unit securely.

Regarding the case of the battery, the box and lid are firmly fixed by welding or the like, so that in the fitted portion of the terminal into the lid, it is required to keep the fitting property of the terminal not to slip out from the lid, the sealing property for preventing from leaking the electrolytes contained in the case and gases generated in the battery, and the insulating property between the terminal and the case.

So, in the battery manufacturing process, especially when fitting the terminal into the through hole formed in the lid, it is important to secure the sealing property of the fitted portion.

Patent Literature 1 discloses a battery having an electric terminal projecting from a lid of the battery, in which an insulating member is arranged between the lid and terminal and the lid is provided with a flanged portion standing out around the insulating member, enabled to keep the sealing property between the lid and the terminal by press-fitting the flanged portion from the direction parallel to the lid, that is the direction perpendicular to the thickness direction of the lid.

Unfortunately, according to the use of the battery, a temperature cycle including heating and cooling is repeated, whereby the press-fitted portion is loosened to return the former shape and the sealing property is degraded.

[Patent Literature 1] JP 2005-302625 A

### DISCLOSURE OF INVENTION

### Problems to be Solved by the Invention

The objective of the present invention is to provide an unexpected battery including a case and an electric terminal fitted to the case with projecting therefrom, provided with high sealing property at the fitted portion between the case and terminal.

### Means of Solving the Problems

The first aspect of the present invention is a method of manufacturing a battery, which includes a case provided with a through hole; an electric terminal fixed to the through hole with projecting outward from the case; and an insulating member interposed between the case and the terminal. In the embodiment of the method as the first aspect, the terminal is provided with a groove formed on the outer periphery of the terminal along the whole circumference, the groove having an edge line at the outer side of the case, a flanged portion standing out from the case is formed around the through hole, the terminal surrounded by the insulating member is inserted into the through hole such that the groove faces a section of the lid having thickness in the axial direction of the terminal, and an upper area in the flanged portion above the edge line is press-fitted from outside of the case to deform plastically and to fix the terminal to the through hole.

Due to the pressing to the flanged portion, a press-fitted portion expanded inwardly from the through hole, and the press-fitted portion applies pressure to the terminal, thereby strongly fixed to the hole.

Preferably in the method of the first aspect, the flanged portion is pressed from the top thereof to the edge line of the groove.

In the advantageous embodiment, a press volume to the flanged portion is larger than a groove volume of the groove.

In the preferable embodiment, the lid is made of steel.

The material of the lid may be the material having the same strength as the steel or more.

The other embodiment of the aspect of the present invention is a method of manufacturing a battery, which includes a case provided with a through hole; an electric terminal fixed to the through hole with projecting outward from the case; and an insulating member interposed between the case and the terminal. In the embodiment of the method as the first aspect, the terminal is provided with a groove formed on the outer periphery of the terminal along the whole circumference, the groove having an edge line at the outer side of the case, a flanged portion standing out from the case is formed around the through hole, the terminal surrounded by the insulating member is inserted into the through hole such that the groove faces an inside wall of the flanged portion projecting outward from the lid, and an upper area in the flanged portion above the edge line is press-fitted from outside of the case to deform plastically and to fix the terminal to the through hole.

Due to the pressing to the flanged portion, a press-fitted portion expanded inwardly from the through hole, and the press-fitted portion applies pressure to the terminal, thereby strongly fixed to the hole.

In the preferable embodiment, the radial width of the flanged portion is larger than the height between the inside wall of the lid formed with the through hole and the top of the flanged portion.

The second aspect of the present invention is a battery which includes a case provided with a through hole; an electric terminal fixed to the through hole with projecting outward from the case, and the terminal has a groove formed on the outer periphery of the terminal along the whole circumference, the groove having an edge line at the outer side of the case; an insulating member interposed between the case and the terminal; and a flanged portion standing out from the case, located around the through hole; wherein the fitted portion between the terminal and the through hole is formed by performing a press-fitting on an upper area in the flanged portion above the edge line from outer side of the case for plastic deformation, with the terminal and the insulating member inserted in the through hole such that the groove faces a section of the lid having thickness in the axial direction of the terminal.

Due to the pressing to the flanged portion, a press-fitted portion expanded inwardly from the through hole, and the press-fitted portion applies pressure to the terminal, thereby strongly fixed to the hole.

Preferably in the battery of the first aspect, the flanged portion is pressed from the top thereof to the edge line of the groove.

In the advantageous embodiment, a press volume to the flanged portion is larger than a groove volume of the groove.

In the preferable embodiment, the lid is made of steel.

The material of the lid may be the material having the same strength as the steel or more.

The other embodiment of the second aspect of the present invention is a battery which includes a case provided with a through hole; an electric terminal fixed to the through hole with projecting outward from the case, and the terminal has a groove formed on the outer periphery of the terminal along the whole circumference, the groove having an edge line at the outer side of the case; an insulating member interposed between the case and the terminal; and a flanged portion standing out from the case, located around the through hole; wherein the fitted portion between the terminal and the through hole is formed by performing a press-fitting on an upper area in the flanged portion above the edge line from outer side of the case for plastic deformation, with the terminal and the insulating member inserted in the through hole such that the groove faces an inside wall of the flanged portion projecting outward from the lid.

Due to the pressing to the flanged portion, a press-fitted portion expanded inwardly from the through hole, and the press-fitted portion applies pressure to the terminal, thereby strongly fixed to the hole.

In the preferable embodiment, the radial width of the flanged portion is larger than the height between the inside wall of the lid formed with the through hole and the top of the flanged portion.

### Effect of the Invention

According to the present invention, the battery is obtained that includes a case and an electric terminal fitted to the case with projecting therefrom, provided with high sealing property at the fitted portion between the case and terminal.

### BRIEF DESCRIPTION OF DRAWINGS

FIG. 1 depicts a battery according to the present invention.

FIG. 2 is an enlarged section view illustrating a fitted portion of the case and terminal.

FIG. 3 is an enlarged view illustrating the pressing to a flanged portion.

FIG. 4 depicts a thickness of a holding portion of the flanged portion after the pressing.

FIG. 5 is a plan view showing a pressing area in the flanged portion by using a press tool.

FIG. 6 depicts a relationship between the press volume to the flanged portion and a groove volume of a groove.

FIG. 7 depicts a relationship between the height of the flanged portion and the press length to the flanged portion.

FIG. 8 depicts the other battery according to the present invention.

FIG. 9 depicts a relationship among a thickness of a holding portion, the height of the flanged portion, and the press length to the flanged portion.

### EXPLANATION OF NUMERALS

10 battery
30 case
32 lid
33 through hole
34 flanged portion
40 electric terminal
44 groove
45 upper edge line
50 insulating member

### THE BEST MODE FOR CARRYING OUT THE INVENTION

Referring to FIG. 1, the structure of a battery 10 as an embodiment of the present invention is explained below.

The battery 10 is composed as a rechargeable secondary battery such as a lithium ion secondary battery, nickel-metal hydride battery and the like.

As shown in FIG. 1, the battery 10 includes a power generating element 20 contained in a case 30. The case 30 is penetrated by electric terminals 40 projecting outward.

The element 20 is made of an electrode body with electrolyte impregnation, which is formed by laminating or winding a positive electrode, a negative electrode and a separator. When charging or discharging the battery 10, a chemical reaction is occurred in the element 20 (in detail, the ion moves between the positive and negative electrodes through the electrolytes), so the battery 10 serves as the rechargeable secondary battery.

The case 30 includes a box 31 and a lid 32 and is made of steel. The box 31 has a closed-end shape and an opening at one side, and contains the element 20. The lid 32 has a shape in accordance with the opening of the box 31, which covers the opening of the box 31 and is fixed to the box 31.

Note that the materials of the box 31 and the lid 32 of the case 30 are not limited to steel. In the embodiment, the steel is used considering the strength of the box 31 and the lid 32, for example, the materials may be metal materials having the same strength as the steel or more, or the materials such as aluminum used for the popular batteries.

The terminals 40 are configured as a positive terminal or a negative terminal, each of which is fitted into the case 30 projecting from the outer periphery of the case 30. The terminals 40 are electrically connected to the positive electrode or negative electrode of the element 20 via suitable wires such as lead terminals, and the electrodes 40 transmit the electric power between the inside and outside of the battery 10. The terminals 40 are electric paths to the outside. The terminal 40 has a thread portion (not shown) formed at the periphery, configured by thread rolling.

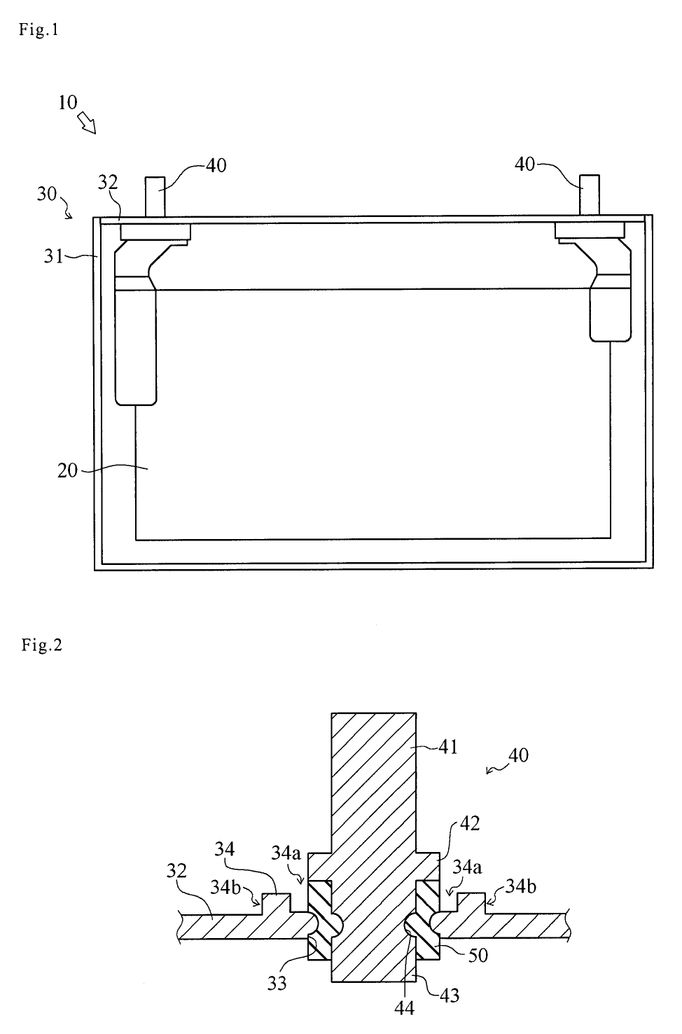

Referring to FIGS. 2 to 4, the fitting embodiment among the lid 32 of the case 30 and the terminals 40 is explained below.

The terminals 40 are fitted into the lid 32 of the case 30 interposing insulating members 50 therebetween, which secure the insulating property between the terminals 40 and the case 30. When fitting the terminals 40, a part of the lid 32 is press-fitted to press and fix the terminals 40 and insulating members 50 firmly. Thus, the sealing property between the lid 32 and the terminals 40 is secured.

As shown in FIG. 2, the lid 32 has a pair of through holes 33 each of which the terminal 40 passes through.

The holes 33 are formed at predetermined diameters and penetrate the lid 32 in the thickness direction (in the vertical direction shown in drawings).

The hole 33 has an edge defined by a flanged portion 34.

The flanged portion 34 is formed at the edge of the hole 33 and stands out from the case 30 from inside to outside thereof (in the vertical direction shown in drawings), thereby formed as a thick portion. The flanged portion 34 is projected from the outer face of the lid 32, and defines the hole 33 at the inner wall thereof.

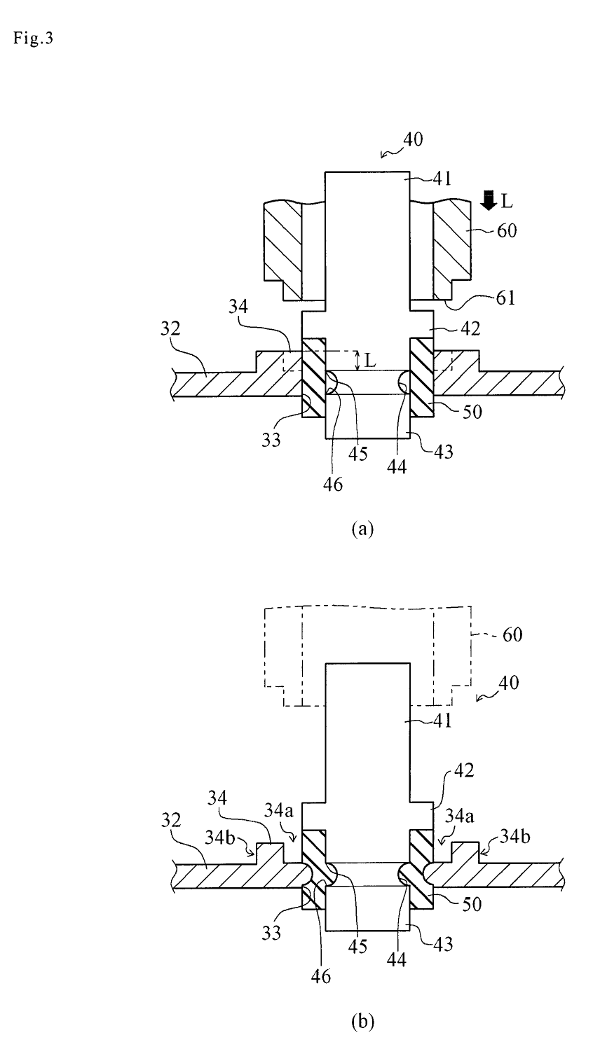

The part of the lid 32 (around the hole 33) is plastically deformed to form the flanged portion 34, which is formed by burring processing, deep drawing, damming, or the combination of these methods. In the embodiment, as shown in FIGS. 2, 3, the flanged portion 34 has the inside wall defining the hole 33 and including the bottom end which has a cross section formed as a right angle by means of press molding or the like.

The terminal 40 is configured as a round terminal having circular section, and as shown in FIGS. 2 and 3, has a projecting portion 41, an enlarged portion 42 and a fitted portion 43.

The projecting portion 41 is formed at one end of the terminal 40 (the end located outside of the battery 10, and the upper end shown in the drawing), has a column shape, and projects outward from the case 30. The projecting portion 41 is used as a connecting part to external devices (e.g. a power source, a device using the electric power of the battery, other batteries), and the connecting terminals of the external devices are fixed to the projecting portion 41. In the respect that the projecting portion 41 serves as the connecting part to the external devices, the portion is formed with the thread portion at the outer periphery thereof.

The enlarged portion 42 is formed continuously to the projecting portion 41, and has a column shape enlarged toward radial direction. The outer diameter of the enlarged portion 42 is larger than that of the projecting portion 41 and fitted portion 43, and when connecting the connecting terminal to the projecting portion 41, the connecting terminal face-contacts the enlarged portion, thereby lowering the connecting resistance. The enlarged portion 42 has the largest outer diameter in the terminal 40, the outer diameter is set in accordance with the inner diameter of the hole 33 provided in the lid 32. For example, it is advantageous to set the outer diameter of the enlarged portion 42 as the same as the inner diameter of the hole 33 and the same as the outer diameter of the insulating member 50 so that the surface area of the enlarged portion is preferably set as large as possible. The lower end face of the enlarged portion 42 is engaged with the insulating member 50.

The fitted portion 43 is formed at the other end of the terminal 40 (the end located inside of the battery 10, and the lower end shown in the drawing), and has a substantially column shape for fitting to the lid 32 and for connecting to the lead terminals connected with the element 20. The length in the axial direction of the fitted portion 43 is set larger than the thickness of the lid 32 (that is the extended length of the flanged portion 34) and set as the same as that of the insulating member 50 or longer. The insulating member 50 is arranged to surround the outside (strictly explaining, the whole circumference of a part in the axial direction) of the fitted portion 43.

As shown in FIGS. 2 and 3, the fitted portion 43 includes a groove 44 at the middle portion thereof.

The groove 44 is a semicircular (or semioval) recess formed along the outer periphery of the fitted portion 43, and has a predetermined groove width (vertical length in the figures). The groove width of the groove 44 is set as the same as the thickness of the lid 32.

The groove 44 has an upper edge line 45 formed at one side (upper side) and a lower edge line 46 formed at the other side (lower side).

The upper edge line 45 defines one edge (upper edge) of the groove 44, serves as a boundary to the fitted portion 43, and is formed substantially as a right angle. The lower edge line 46 defines the other edge (lower edge) of the groove 44, serves as a boundary to the fitted portion 43, and is formed substantially as a right angle. That is, the groove 44 is formed along the whole circumference of the fitted portion 43, and has a semicircular (or semioval) shaped bottom between the upper and lower edge lines 45 and 46 having the predetermined groove volume Vg.

The bottom shape of the groove 44 may be formed to have at least an edge line at the outer side of the case 30 and have the predetermined groove volume, for example may be formed in the square groove or triangle groove.

The insulating member 50 for insulating among the case 30 and the terminal 40 is interposed between the flanged portion 34 of the lid 32 and the fitted portion 43 of the terminal 40.

The insulating member 50 has a shape in accordance with the flanged portion 34 and the fitted portion 43, in the embodiment, has the tube shape. The insulating member 50 surrounds the fitted portion 43.

The length in the axial direction of the insulating member 50 is set as the same as the fitted portion 43 or longer. In detail, the axial length of the insulating member 50 is set such that there exists the proper length for insulating between the outer periphery of the terminal 40 (especially the enlarged portion 42 and fitted portion 43) and the flanged portion 34 when the terminal 40 is fixed to the lid 32.

The insulating member 50 is preferably made of material with fine high-temperature creep characteristic, that is the material having the long creep property against the temperature cycle of the battery 10, e.g. PEEK (poly (etheretherketone)).

The insulating member 50 also acts as the sealing member for securing the sealing property in the battery 10.

As shown in FIG. 2, the inside portion of the projected end of the flanged portion 34 is wholly press-fitted (in other words, the material plastically moves in response to press) from outside of the battery 10 (upper side in FIG. 2).

Thus, at the inside portion of the flanged portion 34, a press-fitted portion 34a is formed so as to expand toward inside.

The press-fitted portion 34a expanded inward presses the insulating member 50, and the pressure is applied to the insulating member 50 as contact surface pressure. The portion in the insulating member 50 to which the contact surface pressure applied by the flanged portion 34a elastically deforms inward, and the force in accordance with the elastic deformation is applied to the fitted portion 43 as contact surface pressure.

Thus, the flanged portion 34 is press-fitted from upper side at the inside portion of the upper end, forming the press-fitted portion 34a expanding inward, thereby the contact surface pressure is transmitted from the flanged portion 34 to the fitted portion 43 through the insulating member 50. Due to the transmitted contact surface pressure, the fitted portion 43 receives the fitting force so that the terminal 40 is fixed to the lid 32 of the case 30.

Due to the plastic deformation of the press-fitted portion 34a and the elastic deformation of the insulating member 50, there is no gap among the flanged portion 34, the insulating member 50 and the fitted portion 43, occurring high bonding force therebetween, and the sealing property between the case 30 and terminal 40 is secured, thereby keeping the sealing property of the battery 10. The press-fitted portion 34a is press-fitted in the direction perpendicular to the expanding direction, so that the press-fitted portion does not return (loosen) according to the high contact surface pressure and friction force acting on the expanded portion.

As shown in FIG. 3, the flanged portion 34 is pressed with a press tool 60 by the predetermined pressing length L (pressing depth of the press tool 60). The press tool 60 is a tubular press mold having an opening through which the terminal 40 travels, and has a pressing blade 61 at the end. The blade 61 has a predetermined thickness in the radial direction and extends from the end of the tool 60 at the predetermined length.

The press tool 60 is movable by means of the driving device, and the pressing blade 61 presses the inside portion of the flanged portion 34, whereby the material is plastically deformed and press-fitted.

As shown in FIG. 3(a), the terminal 40 is arranged, when inserted into the hole 33, such that the upper edge line 45 of the groove 44 is positioned at the bottom dead end of the pressing by the press tool 60. In other words, the terminal 40 is inserted into the hole 33 such that the upper edge line 45 of the groove 44 is positioned at the pressing length L below from the top of the flanged portion 34.

When pressing the terminal 40 set in this manner, the upper area in the flanged portion than the upper edge line 45 is pressed, and, as shown in FIG. 3(b), the lower end of the press-fitted portion 34a formed by the pressing is positioned as same as the upper edge line 45 of the groove 44.

Thus, the upper edge line 45 is located in the acting direction of the pressing force applied to the terminal 40 and insulating member 50 from the press-fitted portion 34a. As a result, the insulating member 50 pressed by the press-fitted portion 34a sticks strongly to the upper edge line 45 of the groove 44, and therefore the sticking force between the insulating member 50 and the terminal 40, thereby improving the sealing property of the battery 10.

As shown in FIG. 3(a), when pressing the flanged portion 34, the terminal 40 is set in such way that the groove 44 faces the section having thickness of the lid 32. In other words, when pressing the flanged portion 34, the groove 44 is located on the extension line of the lid 32, and the upper edge line 45 of the groove 44 is positioned at the same height as the top of the lid 32 and the lower edge line 46 of the groove 44 is positioned at the same height as the bottom of the lid 32.

In the terminal 40 fixed to the hole 33 of the lid 32, the groove 44 is surrounded by the many portions. Thus, after fixing the terminal 40 into the lid 32, the rigidity of the portion facing the groove 44 is high, thereby securing the bonding strength between the terminal 40 and the insulating member 50 at the groove 44 which greatly contributes to the sealing property of the battery 10 and thereby securing the sealing property at the terminal 40. For example, even when the inner pressure of the battery 10 rises, the break at the fitted portion of the groove 44 is prevented, and the terminal 40 does not slip, thereby improving the pressure resistance of the battery 10.

As shown in FIG. 4, after pressing the flanged portion 34, the thickness R of the holding portion that holds the terminal 40 is determined by the thickness of the lid 32 which faces the groove 44. In the embodiment, the groove 44 faces the thickness portion of the lid 32, whereby the whole existing area of the lid 32 determines the thickness R. As a result, the arrangement of the terminal 40 in the embodiment increases the holding force of the terminal 40, which results in the improvement of the sealing property of the battery 10.

Moreover, the lid 32 is made of steel as a high strength material, thereby securing the rigidity in the existing direction (left and right direction in the drawing) of the lid 32.

Therefore, the resistance (pressure resistance) is improved against the radial external force applied from the periphery of the terminal 40 (via the hole 33) to the lid 32 caused by the inner pressure rising of the battery 10.

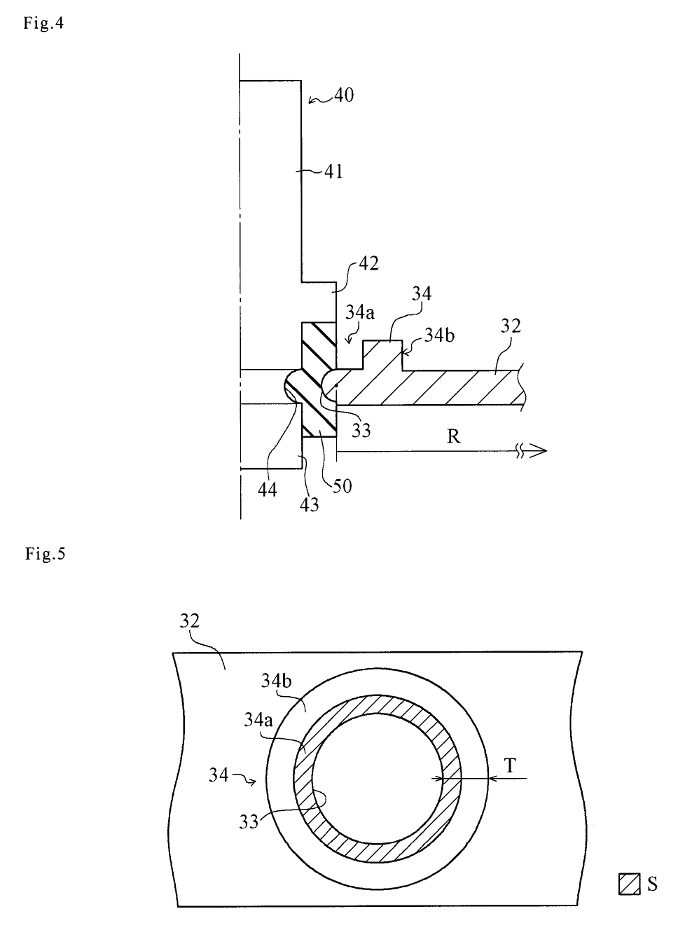

As shown in FIGS. 3, 5, it is preferable that the pressing area S of the tool 60 (the surface area of the pressing blade 61) to the flanged portion 34 is set smaller than the area of the top of the flanged portion 34. The pressing surface of the tool 60 has width smaller than the radial width T of the flanged portion 34, and therefore the pressing area of the tool 60 is set to press the inside portion of the flanged portion 34 and not to press the outer portion of the flanged portion 34.

Thus, after press-forming the press-fitted portion 34a by pressing the flanged portion 34, a remained portion 34b is left in the outer portion of the flanged portion 34. So, the remained portion 34b generates the braking force to restrain the pressing force from dispersing outward when pressing the flanged portion 34.

The pressing force for the press-fitting is prevented from escaping outward, and the press-fitted portion 34a is formed to expand inward (toward the terminal 40).

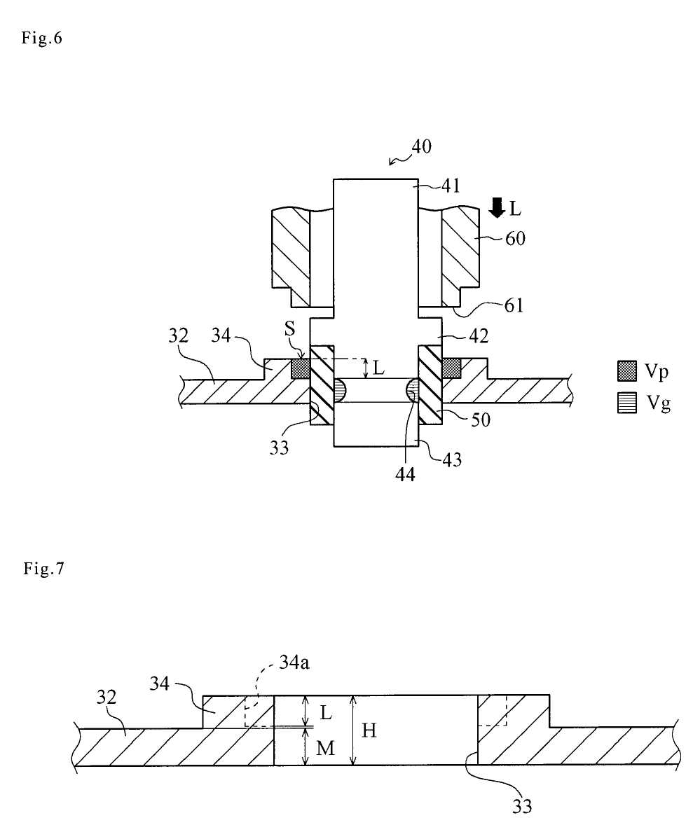

The tool 60 presses at the press volume Vp (see FIG. 6), which is determined by multiplication of the press length L and the pressing area S. The press volume Vp is set larger than the groove volume Vg (see FIG. 6) of the grove 44 (Vp>Vg).

Here, the groove volume Vg of the groove 44 is determined in the manufacturing process of the terminal 40. On the other hand, the press volume Vp is determined by the pressing embodiment of the press tool 60. Especially, the pressing area S of the tool 60 depends on the shape of the blade 61, and the press length L depends on the positional relationship between the top of the flanged portion 34 and the upper edge line 45 of the groove 44.

In the embodiment, the height H (see FIG. 7) of the flanged portion 34, which is defined as the length between the top of the flanged portion 34 (end surface of the portion projected toward the outside of the lid 32) and the inside wall of the lid 32 (bottom depicted in the drawing), is adjusted to change the press length L such that the press volume Vp is set larger than the groove volume Vg of the groove 44.

Thus, pressing at the press volume Vp larger than the groove volume Vg of the groove 44 results in the inwardly expansion of the press-fitted portion 34a in the flanged portion 34, whereby the insulating member 50 is fitted into the groove 44 and the sealing property is improved between the insulating member 50 and the terminal 40.

As shown in FIG. 7, the height H of the flanged portion 34 is a projecting length of the flanged portion 34 from the lid 32, and it should satisfy the following conditions: the condition to be pressed by means of the tool 60 (that is, the press volume Vp is larger than the groove volume Vg of the groove 44); and the strength condition to be configured as a part of the case 30. That is, in the flanged portion 34, there exists the enough material to secure the sufficient strength below the press-fitted portion 34a, after pressing the flanged portion by the press length L to form the press-fitted portion 34a.

Consequently, the height H of the flanged portion 34 is preferably set larger than the summed value of the press length L of the tool 60 and the minimum thickness M that secures the strength as the case 30 (H>L+M).

Note that the minimum thickness M to secure the structural strength of the case 30 indicates the thickness enough to keep the terminal 40 fixed to the hole 33 after pressing and to secure the sealing property of the case 30 and is substantially same as the thickness of the lid 32.

The press length L depends on the location relationship between the lid 32 and the groove 44. When the groove width of the groove 44 is larger than the thickness of the lid 32, considering the thickness of the flanged portion 34 after the press, the lower edge line 46 of the groove 44 is preferably set on the extension from bottom (inside wall) of the lid 32.

In this case, the upper edge line 45 is located above the top (outside wall) of the lid 32, and the height H of the flanged portion 34 is set in accordance with this location.

In the embodiment, the press volume Vp is set larger than the groove volume Vg of the groove 44 so that the press-fitted portion 34a is expanded inward, however the flanged portion 34 may be configured in the given height H and width T to make the press volume Vp being as much as the groove volume Vg. Due to the structure, efficient press operation to the flanged portion 34 is provided.

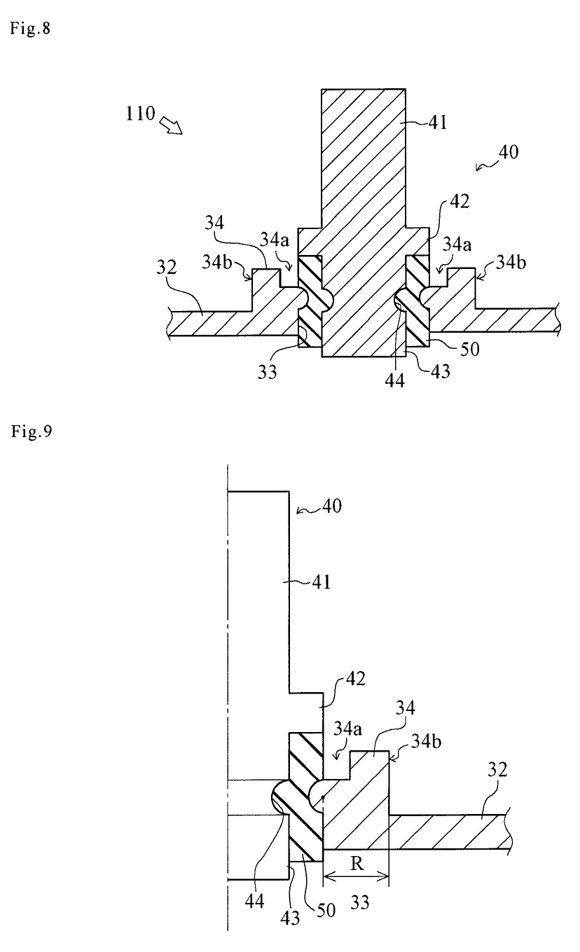

Referring to FIGS. 8, 9, a battery 110 is explained below, that is the other preferable embodiment of the battery, in which the groove 44 of the terminal 40 is located in the flanged portion 34 to face the upper portion than the top of the lid 32.

As shown in FIG. 8, in the battery 110, the terminal is inserted such that the groove 44 is surrounded by the inside wall of the part of the flanged portion 34 (middle portion of the hole 33) which projects from the top of the lid 32. In the battery 110, the groove 44 is not located on the extension of the lid 32.

Particularly, the battery 110 differs from the battery 10 in the positional relationship between the groove 44 and the flanged portion 34 when inserting the terminal 40 into the hole 33. Thus, in the battery 110, the width T of the flanged portion 34 which faces the groove 44 is set large so as to secure the holding force and to enhance the sealing property of the battery 110.

In the battery 110, the basic structures such as pressing to the flanged portion 34 are substantially same as those of the battery 10. Therefore, the battery 110 provides the same acts and effects brought by the pressing process in the battery 10, so the detail explanation is omitted here.

As shown in FIG. 9, as to the battery 110, the holding thickness R is the radial width T of the flanged portion 34. Thus, the radial width T of the flanged portion 34 is preferably set as large as possible, and preferably satisfies the relationship: width T>height H of the flanged portion 34.

In this embodiment, as shown in FIG. 9, the thickness R of the holding portion of the flanged portion 34 that holds the terminal 40 is the width T of the flanged portion 34, and the width T of the flanged portion 34 is set in the large value, thereby providing the sufficient holding force for holding the terminal 40. As a result, the above-described arrangement of the terminal 40 also provides the strong fitting of the terminal 40, thereby improving the sealing property of the battery 110.

### INDUSTRIAL APPLICABILITY

The present invention is applicable to a battery including a case and an electric terminal projecting from the case, especially to the technique of securing sealing property in the through hole formed in the case through which the terminal penetrates.

1. A method of manufacturing a battery comprising: a case provided with a through hole; an electric terminal fixed to the through hole with projecting outward from the case; and an insulating member interposed between the case and the terminal, the method comprising:
providing the terminal with a groove formed on the outer periphery of the terminal along the whole circumference, the groove having an edge line at the outer side of the case;
forming a flanged portion around the through hole, standing out from the case;
inserting the terminal surrounded by the insulating member into the through hole such that the groove faces a section of the lid having thickness in the axial direction of the terminal;
press-fitting an upper area in the flanged portion above the edge line from outside of the case to deform plastically and to fix the terminal to the through hole.

2. The method according to claim 1,
wherein the flanged portion is pressed from the top thereof to the edge line of the groove.

3. The method according to claim 1,
wherein a press volume to the flanged portion is larger than a groove volume of the groove.

4. The method according to claim 1,
wherein the lid is made of steel.

5. A method of manufacturing a battery comprising: a case provided with a through hole; an electric terminal fixed to the through hole with projecting outward from the case; and an insulating member interposed between the case and the terminal, the method comprising:
providing the terminal with a groove formed on the outer periphery of the terminal along the whole circumference, the groove having an edge line at the outer side of the case;
forming a flanged portion around the through hole, standing out from the case;
inserting the terminal surrounded by the insulating member into the through hole such that the groove faces an inside wall of the flanged portion projecting outward from the lid;
press-fitting an upper area in the flanged portion above the edge line from outside of the case to deform plastically and to fix the terminal to the through hole.

6. The method according to claim 5,
wherein the radial width of the flanged portion is larger than the height between the inside wall of the lid formed with the through hole and the top of the flanged portion.

7. A battery, comprising:
a case provided with a through hole;
an electric terminal fixed to the through hole with projecting outward from the case, comprising a groove formed on the outer periphery of the terminal along the whole circumference, the groove having an edge line at the outer side of the case;
an insulating member interposed between the case and the terminal; and
a flanged portion standing out from the case, located around the through hole;
wherein the fitted portion between the terminal and the through hole is formed by performing a press-fitting on an upper area in the flanged portion above the edge line from outer side of the case for plastic deformation, with the terminal and the insulating member inserted in the through hole such that the groove faces a section of the lid having thickness in the axial direction of the terminal.

8. The battery according to claim 7,
wherein the flanged portion is pressed from the top thereof to the edge line of the groove.

9. The battery according to claim 7,
wherein a press volume to the flanged portion is larger than a groove volume of the groove.

10. The battery according to claim 7,
wherein the lid is made of steel.

11. A battery, comprising:
a case provided with a through hole;
an electric terminal fixed to the through hole with projecting outward from the case, comprising a groove formed on the outer periphery of the terminal along the whole circumference, the groove having an edge line at the outer side of the case;
an insulating member interposed between the case and the terminal; and
a flanged portion standing out from the case, located around the through hole;
wherein the fitted portion between the terminal and the through hole is formed by performing a press-fitting on the flanged portion from outer side of the case for plastic deformation, with the terminal and the insulating member inserted in the through hole such that the groove faces an inside wall of the flanged portion projecting outward from the lid.

12. The battery according to claim 11,
wherein the radial width of the flanged portion is larger than the height between the inside wall of the lid formed with the through hole and the top of the flanged portion.
